(19) United States
(12) Patent Application Publication
(10) Pub. No.: US 2010/0036646 A1
(43) Pub. Date: Feb. 11, 2010

(54) ANALYTICAL MODEL PREPARATION METHOD, AND SIMULATION SYSTEM METHOD FOR PREDICTING MOLDING FAILURE

(75) Inventors: Kenji Hisai, Hagagun (JP); Hidemi Morikawa, Hagagun (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 12/536,218

(22) Filed: Aug. 5, 2009

(30) Foreign Application Priority Data
Aug. 8, 2008 (JP) 2008-205201
Mar. 26, 2009 (JP) 2009-077531

(51) Int. Cl. G06F 17/50

(52) U.S. Cl. 703/1; 703/6; 700/200

(57) ABSTRACT

There is provided a method for preparing an analytical model for analyzing a shape of a molded part. The method includes: (a) measuring the shape of the molded part three-dimensionally to obtain shape data; (b) dividing the shape data into two surfaces which define a thickness of the molded part; (c) calculating a deviation between the divided two surfaces, as thickness data; (d) relating the thickness data with the shape data; (e) preparing a shape model of the molded part from CAD data related to the molded part; (f) associating the shape model with the shape data; and (g) imparting, to shape model, the thickness data related with the shape data in accordance with the association in step (f), thereby preparing the analytical model.

This application claims priority from Japanese Patent Applications Nos. 2008-205201, filed on Aug. 8, 2008, and 2009-077531, filed on Mar. 26, 2009, the entire contents of which are hereby incorporated by reference.

### BACKGROUND OF THE INVENTION

1. Technical Field

The present disclosure relates to an analytical model preparation method for preparing an analytical model for analyzing a shape of a molded part. The present disclosure relates to a simulation system for predicting a molding failure of a resin product produced by injection molding.

2. Related Art

### First Problem to be Solved

In the related-art analytical model preparation method, as disclosed in JP-A-2005-196245, by obtaining point group data by measuring three-dimensionally a surface of a fixed mold which corresponds to a front surface of a molded part and a surface of a movable mold which corresponds to a rear surface of the molded part and preparing actually measured models of the respective surfaces from the respective point group data, a separation distance between nodes of the respective actually measured models is calculated as a thickness of the molded part, and by matching the respective actually measured models at a portion where the molds are registered, an analytical model is prepared.

According to the related-art analytical model, although the analytical model can easily be prepared by measuring three-dimensionally the molds, effects of an actual clamping force and an error produced in fastening the two models together could not be taken into consideration, leading to a problem in that an accurate thickness could not be obtained accurately.

### Second Problem to be Solved

Resin products such as automotive bumpers or garnishes are formed by preparing molds having cavities conforming to the shape of a product and injecting a thermoplastic resin into the molds for injection molding. More specifically speaking, in this injection molding, firstly, a movable molds is clamped to a fixed mold, and a cavity conforming to the shape of a product is defined between the movable mold and the fixed mold. Then, a molten resin is injected under a predetermined injection pressure by an injection apparatus so as to fill the cavity with the molten resin. In addition, a dwell pressure is applied to the molten resin when filling it in the cavity. Thereafter, after the molten resin is cooled with the dwell pressure, the molds are opened for removal of a molded product.

In the injection molding described above, in order to obtain a molded part of high quality, the shape of the molds and molding conditions need to be set appropriately, the molding conditions including the total amount, flow rate, temperature and pressure of the molten resin which is injected into the molds. In the event that the shapes of the molds or molding conditions are not appropriately set, irregularities (hereinafter, referred to as “deformation”) are produced on a surface of the molded part.

Then, in recent years, a simulation system has been developed which verifies in advance the generation of such deform (see e.g., JP-A-10-138310). More specifically speaking, in a simulation system described in JP-A-10-138310, a degree of deformation that will be generated in a molded part is predicted by a CAE analysis, and the molding conditions are reset repeatedly and the molds are redesigned by a CAD system until the degree of deformation falls within a predetermined value. By predicting a generation of deformation using the simulation system, before molds are actually manufactured, it is possible to reduce cost and time which would otherwise be required for manufacturing the molds.

Incidentally, in JP-A-10-138310, an irregular amount from a reference surface of the molded part is defined as a degree of deformation, and further, this degree of deformation is calculated based on results obtained from a CAE analysis of a thickness value, pressure integration value, flow temperature and pressurizing time. However, with the degree of deformation that is calculated by this simulation, an actual deformation could not be reproduced with good accuracy, and therefore, a simulation system have been desired which can predict a generation of deformation with higher accuracy.

### SUMMARY OF THE INVENTION

Exemplary embodiments of the present invention address the foregoing issues and other issues not described above. However, the present invention is not required to overcome the problems described above and, thus, some implementations of the present invention may not overcome the specific problems described above.

It is an aspect of the present invention to provide an analytical model preparation method for preparing an analytical model with high analytical accuracy which can reproduce the thickness of an actual molded part.

According to one or more aspects of the present invention, there is provided a method for preparing an analytical model for analyzing a shape of a molded part. The method includes: (a) measuring the shape of the molded part three-dimensionally to obtain shape data; (b) dividing the shape data into two surfaces which define a thickness of the molded part; (c) calculating a deviation between the divided two surfaces, as thickness data; (d) relating the thickness data with the shape data; (e) preparing a shape model of the molded part from CAD data related to the molded part; (f) associating the shape model with the shape data; and (g) imparting, to shape model, the thickness data related with the shape data in accordance with the association in step (f), thereby preparing the analytical model.

According to the present invention, the thickness data based on the actual molded part can be imparted to the analytical model, whereby effects of the actual clamping force and an error produced in fastening the two molds can be reflected to the analytical model. Thus, it is possible to prepare the analytical model with high analytical accuracy which can reproduce the thickness of the actual molded part.

According to one or more aspects of the present invention, step (f) includes: associating coordinate point groups of the shape model that are derived from the shape data with coordinate point groups of the shape data that are derived from the shape data. Step (g) includes: imparting the thickness data related to the shape data, to a coordinate point of the shape model which is closest to a coordinate position of the shape data.

According to the present invention, the thickness data can be easily imparted to an appropriate position of the shape data, whereby it is possible to prepare the analytical model with high analytical accuracy which can reproduce the thickness of the actual molded part.

According to one or more aspects of the present invention, step (d) includes: relating the thickness data with the shape data of one of the two surfaces, and step (f) includes: associating the shape data of said one surface with a portion of the shape model which corresponds to said one surface.

According to the present invention, the shape data and the shape model can be associated with each other with high accuracy, and further the thickness data can be imparted to the shape model in an ensured fashion. Therefore, it is possible to prepare the analytical model with high analytical accuracy which can reproduce the thickness of the actual molded part.

Furthermore, it is an aspect of the present invention to provide a simulation system which can grasp the generation of a molding failure with high accuracy.

According to one or more aspects of the present invention, there is provided a simulation system for predicting a molding failure of a resin product through simulation of a process of manufacturing a resin product by injection molding. The system includes: a fluidity analysis executing section that executes a fluidity analysis of a molten resin which is injected into a product shape under certain molding conditions; an actual mass calculating section that calculates an actual mass of the molten resin for each element, based on the result of the fluidity analysis; a required mass calculating section that calculates a required mass of the molten resin for each element, based on the result of the fluidity analysis; an ideal mass calculating section that calculates an ideal resin mass of the molten resin for each element; and a molding failure determination section that determines a molding failure for each element, based on an index calculated by dividing a deviation between the actual mass and the required mass by the ideal mass.

According to one or more aspects of the present invention, there is provided a method of predicting a molding failure of a resin product through simulation of a process of manufacturing a resin product by injection molding. The method includes: (a) executing a fluidity analysis of a molten resin which is injected into a product shape under certain molding conditions; (b) calculating an actual mass of the molten resin for each element, based on the result of the fluidity analysis; (c) calculating a required mass of the molten resin for each element, based on the result of the fluidity analysis; (d) calculating an ideal resin mass of the molten resin for each element; and (f) determining a molding failure for each element, based on an index calculated by dividing a deviation between the actual mass and the required mass by the ideal mass.

According to the present invention, by determining the molding failure on each element based on the index which is calculated by paying attention to the amount of the molten resin for each element, the generation of a molding failure can be grasped with high accuracy. In addition, by determining the shapes of the molds and molding conditions through the simulation so as to prevent a molding failure, time and cost for preparation of molds can be reduced while increasing the quality of products.

According to the simulation system of the invention, by determining a molding failure in each element based on the index determined by paying attention to the molten resin amount in each element, the occurrence of molding failure can be grasped with high accuracy. In addition, by carrying out the simulation, so as to determine mold shapes and molding conditions in such a manner that no molding failure occurs, time and cost required for preparation of molds can be reduced while increasing the quality of molded products.

### BRIEF DESCRIPTION OF THE DRAWINGS

FIG. 1 is an overall block diagram of an analytical model preparation system according to a first exemplary embodiment of the invention;

FIG. 2 is a flowchart showing operations of the analytical model preparation method according to the first exemplary embodiment;

FIGS. 3A to 3E are explanatory diagrams showing the details of operations in STEPS 11 to 16 in FIG. 2;

FIGS. 4A to 4C are explanatory diagrams showing the details of operations in STEPS 21 to 23 in FIG. 2;

FIGS. 5A to 5C are explanatory diagrams showing the details of operations in STEPS 31 to 33 in FIG. 2;

FIG. 6 is a block diagram showing a schematic configuration of a simulation system according to an second exemplary embodiment of the invention;

FIG. 7 is a diagram showing a specific example of mold shape data according to the second exemplary embodiment;

FIGS. 8A to 8C are diagrams showing a specific procedure of manufacturing a resin product by actual injection molding;

FIG. 9 is a flowchart showing a procedure of determining a molding failure by an injection molding simulation according to the second exemplary embodiment;

FIG. 10 is a diagram showing a triangular element according to the second exemplary embodiment;

FIG. 11 is a diagram showing the configurations of PVT curves according to the second exemplary embodiment; and

FIG. 12 is a diagram showing the results of the injection molding simulation according to the second exemplary embodiment.

### DETAILED DESCRIPTION OF EXEMPLARY EMBODIMENTS

### First Exemplary Embodiment

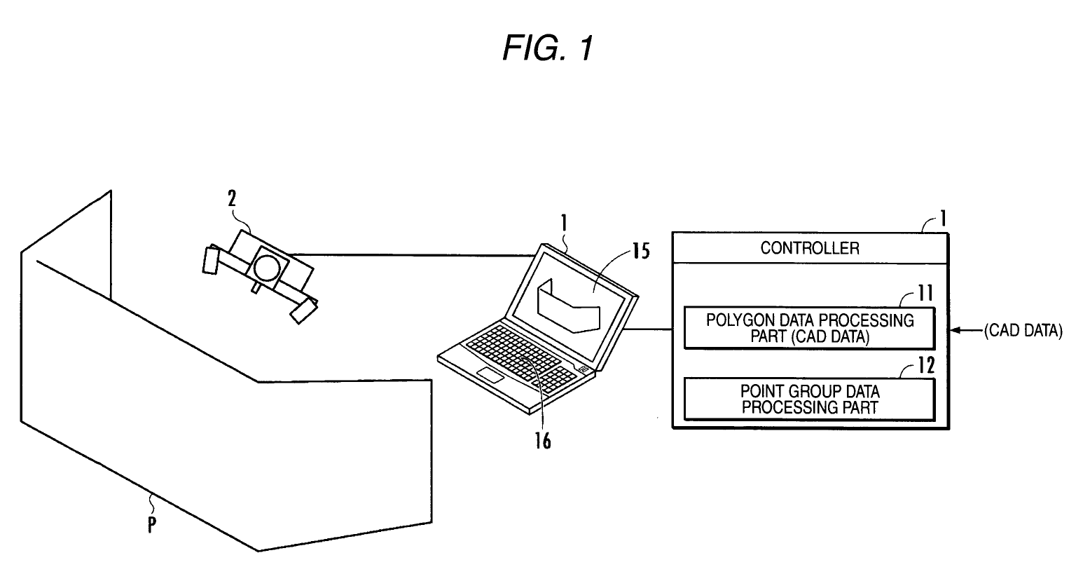

As a first exemplary embodiment of the invention, an analytical model preparation system for preparing an analytical model for analyzing a shape of a resin molded part and an analytical model preparation method which is executed by the above system will be described by reference to FIGS. 1 to 5C.

Firstly, referring to FIG. 1, an overall configuration will be now described. An analytical model preparation system according to this embodiment includes a controller 1 and a three-dimensional measuring device 2 which is connected to the controller 1.

The controller 1 is, for example, a processor which is made up of a general computer system such as a personal computer or a work station and includes at least a polygon data processing part 11 and a point group data processing part 12. In addition, the controller 1 includes a display part 15 and an input part 16 and can be connected to external equipment through an input/output port (not shown).

The three-dimensional measuring device 2 is a device for measuring a surface shape of a molded part P and outputting the shape of the measured surface as point group data. For example, an optical three-dimensional measuring device is used as the three-dimensional measuring device 2. The optical three-dimensional measuring device measures a surface shape in a non-contact state by virtue of interference with reflected light which is produced by radiating a laser beam onto the surface of the molded part P.

The polygon data processing part 11 of the controller 1 is a processing part for executing an operation of editing polygon data, and specifically speaking, the polygon data processing part 11 can edit the integration or separation of a polygon. In addition, the polygon data processing part 11 has an additional function of converting point group data to polygon data.

Specifically, the polygon data processing part 11 executes an operation of converting point group data outputted from the three-dimensional measuring device 2 into polygon data of a molded part P (which corresponds to shape data of the invention), an operation of dividing the polygon data into two surfaces which define the thickness of the molded part P, and an operation of calculating a deviation of the divided surfaces as thickness data. The polygon data processing part 11 executes an operation of generating polygon data from the CAD data.

The point group data processing part 12 of the controller 1 is a processing part which executes an operation of editing the point group data. Specifically speaking, the point group data processing part 12 performs an operation of processing coordinates values which configure the point group data and vector values which connect the coordinate values with each other. In addition, the point group processing part 12 has an additional function of converting polygon data into point group data.

Specifically, the point group data processing part 12 executes a point grouping operation of extracting coordinate points in three directions of X, Y, Z from the polygon data of the molded part P, a model associating operation of calculating distances between the coordinate points so as to extract a closest coordinate point and a thickness imparting operation of exchanging thickness data.

In addition, the display part 15 which the controller 1 includes is a display on which the process results of the controller 1 are to be displayed. Additionally, the input part 16 is a keyboard or a mouse, which the user uses in inputting instructions and other inputs into the controller 1.

Further, the controller 1 can capture CAD data of a molded part or the like and output the processing results of the controller 1 through the input/output port (not shown).

In addition, in this embodiment, the respective processing parts 11, 12 may be configured by hardware such as a CPU, a ROM, a RAM, and these CPU, ROM, RAM and the like may be configured by common hardware, or part or the whole thereof may be configured different hardware.

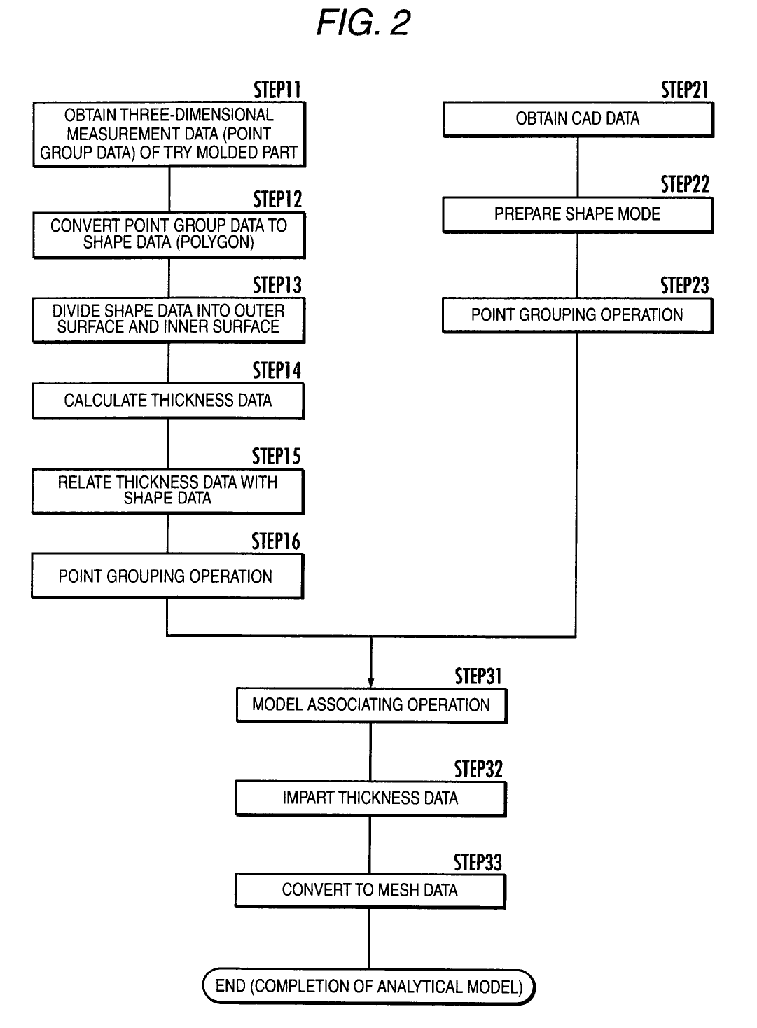

Next, referring to a flowchart shown in FIG. 2, the analytical model preparation method will be described.

In the analytical model preparation method according to this embodiment, operations (STEPS 11 to 16) is related to a try molded part P which is experimentally formed by the use of molds for injection molding a resin molded part, and operations (STEPS 21 to 23) is based on CAD data in which design values of the resin molded part are recorded. The operations (STEP 11 to 16) and the operations (STEPS 21 to 23) are performed in parallel.

Firstly, the operations related to the try molded part P will be described.

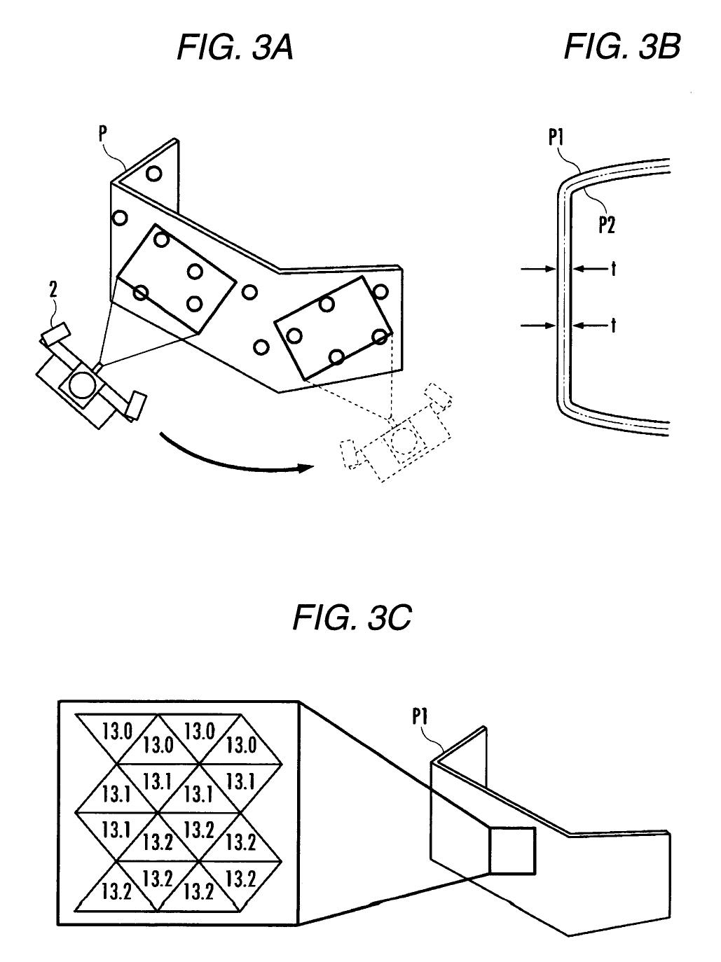

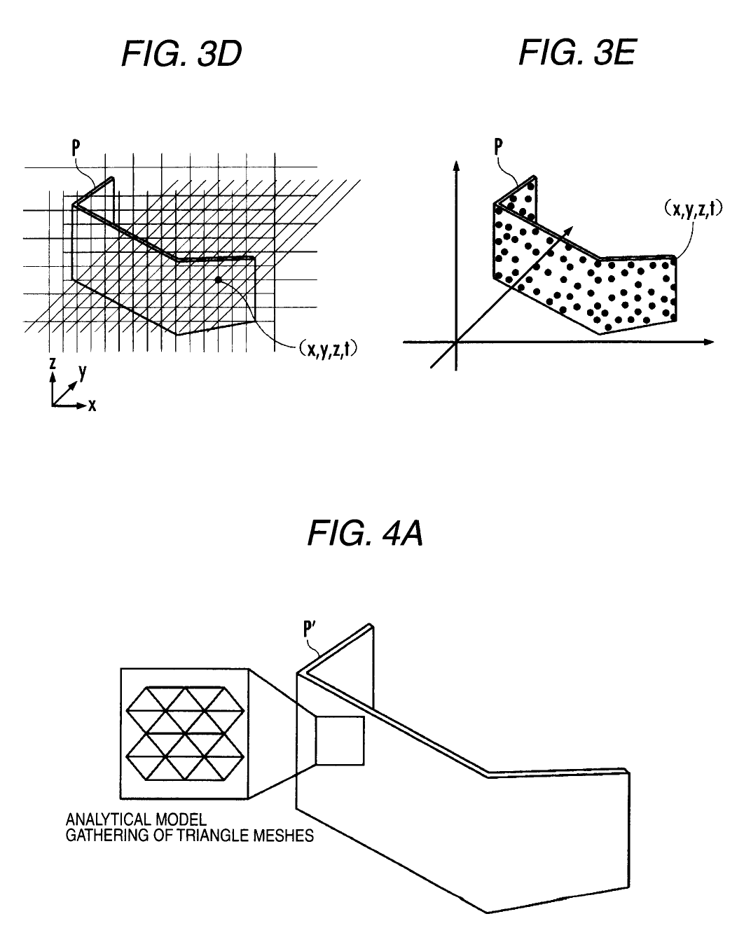

When a try molded part P is completed, the user performs a three-dimensional measurement on the try molded part P by the use of the three-dimension measuring device 2. In the three-dimensional measurement, as shown in FIG. 3A, a sealing is performed on the try molded part P to specify measuring points, and all surfaces of the try molded part P are then three-dimensionally measured. Then, the controller 1 obtains sequentially point group data on each measured surface which is outputted from the three-dimensional measuring device 2 (STEP 11). The point group data are coordinate point group data in which coordinate points in a three-dimensional coordinate system are specified.

Next, the polygon data processing part 11 of the controller 1 converts the point group data into shape data which are made up of polygon data having a predetermined volume (STEP 12) and then divides the shape data into an outer surface P1 and an inner surface P2, each of which defines the thickness of the try molded part, as shown in FIG. 3B (STEP 13).

Next, the polygon data processing part 11 calculates a distance (deviation) between the outer surface P1 and the inner surface P2 as thickness data t (STEP 14). Then, as shown by numerical values in FIG. 3C, the thickness data t are related with shape data of each polygon which is situated on the outer surface P1 (STEP 15).

Next, the point group data processing part 12 performs a point grouping operation of converting the shape data (the polygon data) of the try molded part P into coordinate positions in an XYZ coordinate system (STEP 16). Specifically speaking, in this point grouping operation, as shown in FIG. 3D, intersections between lattice lines which are provided at constant intervals in X, Y, Z directions and the shape data are extracted as coordinate point groups, and thickness data related with the shape data of the outer surface P1 are ported to each coordinate point. The thickness data are ported to not only coordinate points which correspond to the outer surface P1 but also all coordinate points (coordinate points on the inner surface P2) which constitute the thickness.

The porting of the thickness data is performed on all the intersections, whereby as shown in FIG. 3D, coordinate point group data of the try molded part P can be obtained. In the point group data, the respective thickness data t are added to the respective coordinate points in the three dimensional coordinate system of X, Y, Z.

Next, the operation based on CAD data will be described below.

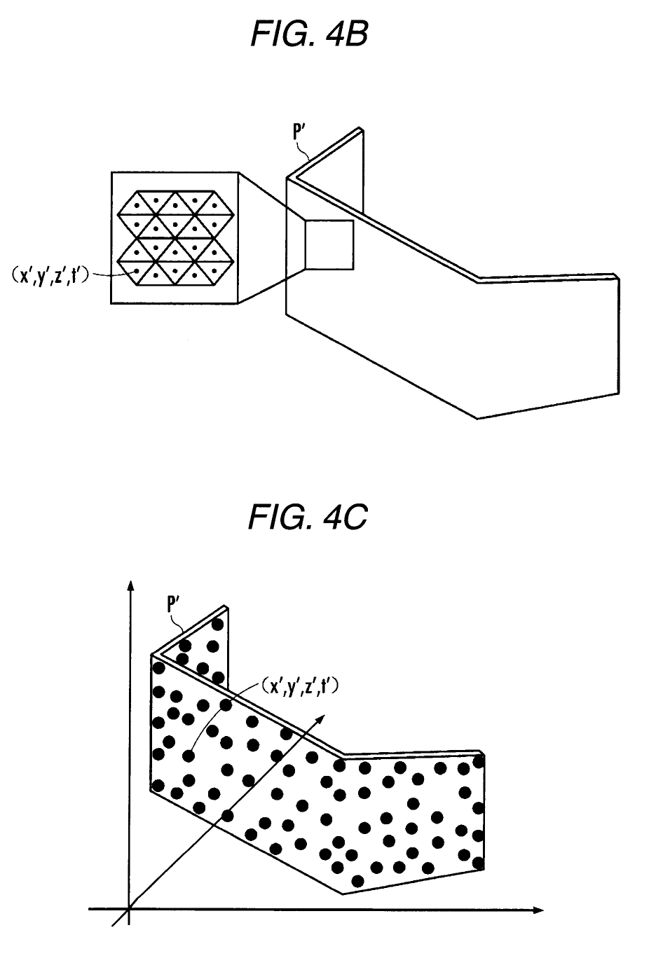

When the controller 1 obtains CAD data in which design values of the resin molded part are recorded (STEP 21), the polygon data processing part 11 prepares a shape model from the CAD data (STEP 22). As shown in FIG. 4A, the shape model is a model P′, which is formed by a triangle mesh which represents a minimum unit of a polygon. In addition, although not shown, a thickness t′ (a design value) of a portion which includes each triangle mesh which is calculated from the CAD data is related with each triangle mesh.

Next, as shown in FIG. 4B, the point group data processing part 12 converts a center position of gravity of each triangle mesh into coordinate point group data in the XYZ coordinate system (STEP 23). This process is performed on all the triangle meshes, whereby coordinate point group data of the shape mode P′ can be obtained as shown in FIG. 4C. In the point group data, the thickness data t′ which is related with each triangle mesh is added to coordinate point positions in the three-dimensional coordinate of X, Y, Z.

Next, the controller 1 executes the following operations (STEPS 31 to 33) based on the operations (STEPS 11 to 16) which are performed on the try molded part P and the operations (STEPS 21 to 23) which are performed on the CAD data.

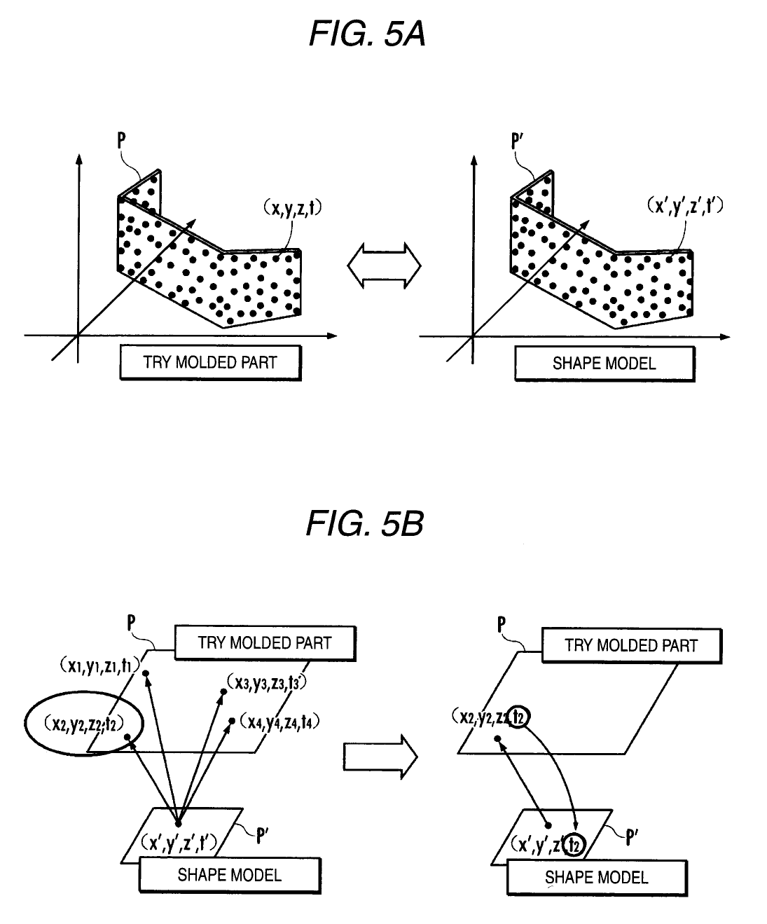

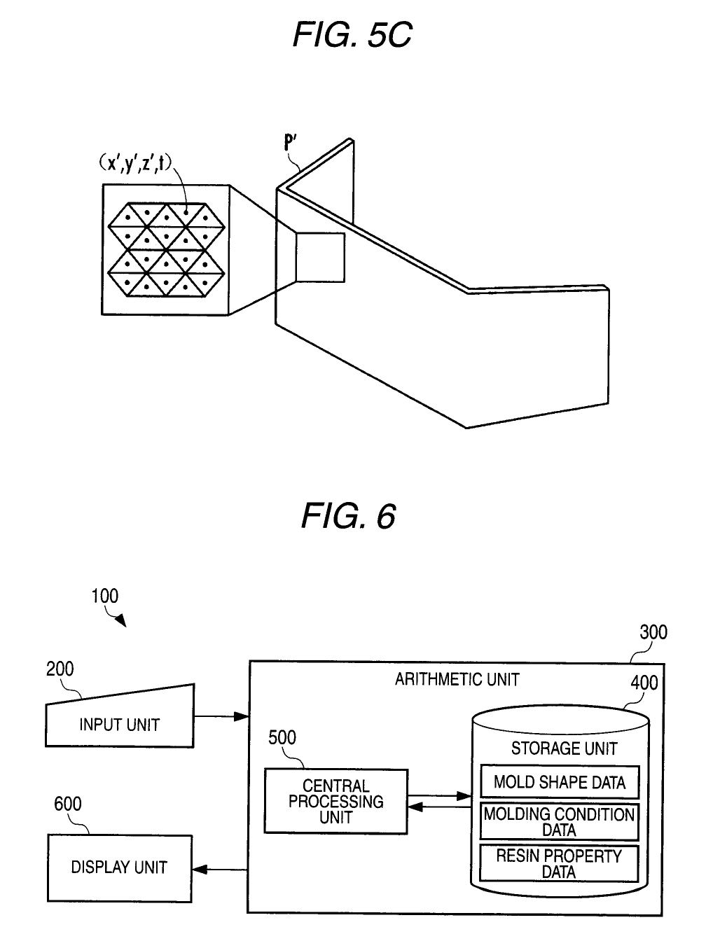

Firstly, as shown exemplarily in FIG. 5A, the point group data processing part 12 performs a model associating operation (STEP 31) of associating the coordinate group data of the try molded part P which were obtained in STEP 16 with the coordinate point group data of the shape model P′ which were obtained in STEP 23. Specifically, as shown in FIG. 5B, one coordinate point (x′, y′, z′) of the shape model P′ is extracted, and then a closest coordinate point (x2, y2, z2) to the coordinate point so extracted is searched from coordinate points (x1, y, z1), (x2, y2, z2), . . . of the try molded part P.

Then, the point group data processing part 12 imparts thickness data t2 which are ported to the closest coordinate point (x2, y2, z2) as thickness data of the coordinate point (x′, y′, z′) of the shape model P′ (STEP 32). Specifically, the thickness data t′ which the coordinate point group of the shape model P′ possesses is converted into the thickness data t2 so imparted.

Then, the point group data processing part 12 executes the operations described above on all the coordinate points of the shape model P′ and, thereafter, as shown in FIG. 5C, converts the coordinate point group data of the shape model P′ into the original triangle mesh data while porting the imparted thickness data (STEP 33). Thus, the series of operations is ended.

By this series of operations, the analytical model can be prepared in which the thickness data based on the actual try molded part P are given to the shape model P′, whereby effects of an actual clamping force and an error produced in fastening the two molds can be reflected to the analytical model. In this way, it is possible to make the analytical model with high analytical accuracy, which can reproduce the thickness of an actual molded part.

In STEP 32 of this embodiment, the closest coordinate point of the try molded part P is searched from the respective coordinate points of the shape model P′ to impart the thickness data. However, the present invention is not limited thereto. For example, a constant threshold with respect to the distance may be provided, so that the coordinate point of the try molded part P is searched within the range of the threshold. By adopting this configuration, the impartation of thickness data can be avoided, in the event that no appropriate coordinate point of the try molded part P exists relative to the coordinate point of the shape model P′.

Furthermore, in this embodiment, the model associating operation and the thickness imparting operation in STEPS 31, 32 are executed on all the coordinate points of the shape model P′. However, the thickness data may be given in advance only to the coordinate points of the try molded part P and the outer surface P1 of the shape model P′, and the associating and thickness imparting operations may be executed only on the coordinate points on the outer surface P1. In this case, since only the coordinate points of the outer surface P1 are processed, the impartation of thickness data can easily be implemented by shortening the processing time. In addition, in this case, the imparted thickness data needs to be ported from coordinate points which corresponds to the outer surface P1 to coordinate points on the inner surface P2 of the shape model P′ which define the thickness thereof.

### Second Exemplary Embodiment

Hereinafter, a second exemplary embodiment of the invention will be described based on the drawings. FIG. 6 is a block diagram showing a schematic configuration of a simulation system 100 according to the second exemplary embodiment of the invention.

The simulation system 100 includes: an input unit 200 by which the operator inputs various data and instructions; an arithmetic unit 300 for executing various types of arithmetic operations; and a display unit 600 for display images. As will be described in detail below, in the simulation system 100, a process of manufacturing a resin product through injection molding is simulated by the hardware configuration described above, thereby predicting the generation of a molding failure in the resin product.

The input unit 200 is configured by hardware such as a keyboard or a mouse, which can be operated by the operator. Data or instructions imputed to the input unit 200 are inputted into the arithmetic unit 300.

The display unit 600 is configured by hardware such as a CRT or a liquid crystal display which can display images thereon. For example, an image regarding the results of an injection molding simulation, which will be described later (e.g., image outputted from the arithmetic unit 300) is displayed on a display part of the display unit 600.

The arithmetic unit 300 includes a storage unit 400 and a central processor unit (CPU) 500. The storage unit 400 is configured by a RAM, a ROM, and a hard disk. The central processor unit (CPU) 500 executes various types of programs based on data stored in the storage unit 400 and data inputted from the input unit 200.

In addition to a system program related to execution of the injection molding simulation, which will be described later, various types of data which are referred to in execution of the simulation (e.g., mold shape data, resin properties data and molding conditions data) are stored in the storage unit 400 of the arithmetic unit 300.

The mold shape data are three-dimensional shape data of molds which are used in injection molding, and data are designed or modified by a CAD system.

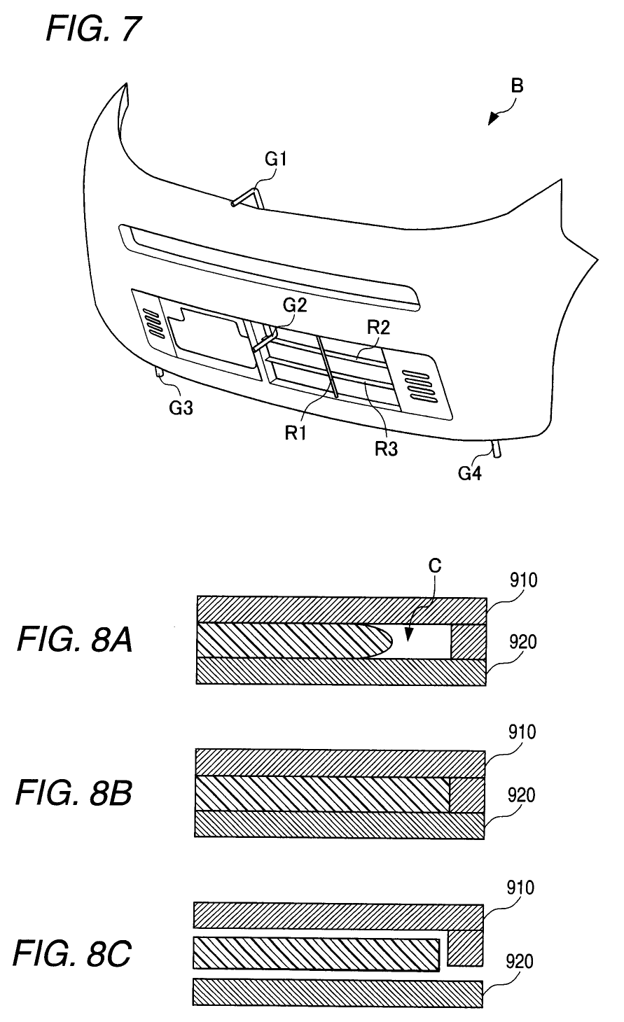

FIG. 7 is a diagram showing a specific example of the mold shape data. In this embodiment, as shown in FIG. 7, the case where a bumper B of a vehicle is manufactured by injection molding will be described hereinafter.

As shown in FIG. 7, in addition to three-dimensional shape data related to the thickness and shape of the molded part, information about positions of plural gates G1, G2, G3, G4 from which molten resin is injected and information about positions of plural runners R1, R2, R3 are included in the mold shape data.

Returning to FIG. 6, the molding conditions data include a state of the molten resin or a state of the molds upon performing injection molding. The configuration of the molding conditions data will be described in detail later.

The resin properties data are related to the properties of a resin used in injection molding. More specifically speaking, in addition to data about the physical properties of the resin such as specific heat, thermal conductivity, set-up temperature, Young's modulus, and Poisson's ratio of the resin, the resin properties data include data regarding a PVT curve (see FIG. 11), which are related to resin pressure, specific volume and temperature with each other.

FIGS. 8A to 8C show diagrams showing a specific procedure of manufacturing a resin product by actual injection molding. As shown in FIGS. 8A to 8C, the injection molding is made up of three steps, which include a filling step (FIG. 8A), a dwell pressure application/cooling step (FIG. 8B) and a mold opening step (FIG. 8C).

In the filling step, a movable mold 910 is clamped to a fixed mold 920, so as to form a cavity C between the movable mold 910 and the fixed mold 920. Further, a molten resin is filled in the cavity C under predetermined molding conditions by an injection apparatus (not shown). Here, in filling the molten resin, a dwell pressure having a predetermined pressure is applied to the molten resin within the cavity C.

In the dwell pressure application/cooling step, while the dwell pressure is applied to the molten resin in the cavity C, the molten resin is cooled. Thus, the molten resin gradually sets and shrinks.

In the mold opening step, the molds are opened after the molten resin has set, and then a molded part is removed from the interior of the molds.

In the injection molding procedure as described above, as a main cause for deformation generated in the molded part, it is considered that the amount of molten resin is insufficient. Namely, in the filling step, in consideration of a probable shrinkage of the molten resin in the post dwell pressure application/cooling step, a larger amount of molten resin than the volume of the cavity C is filled in the cavity C while applying the dwell pressure. However, in the event that the amount of molten resin filled in this step is insufficient relative to the required amount, the molded part shrinks in thickness more than the required thickness, resulting in the generation of deformation. Then, as described below, in the injection molding simulation system of this embodiment, a molding failure determination is made by paying special attention to the amount of molten resin filled within molds which are set in an imaginary fashion.

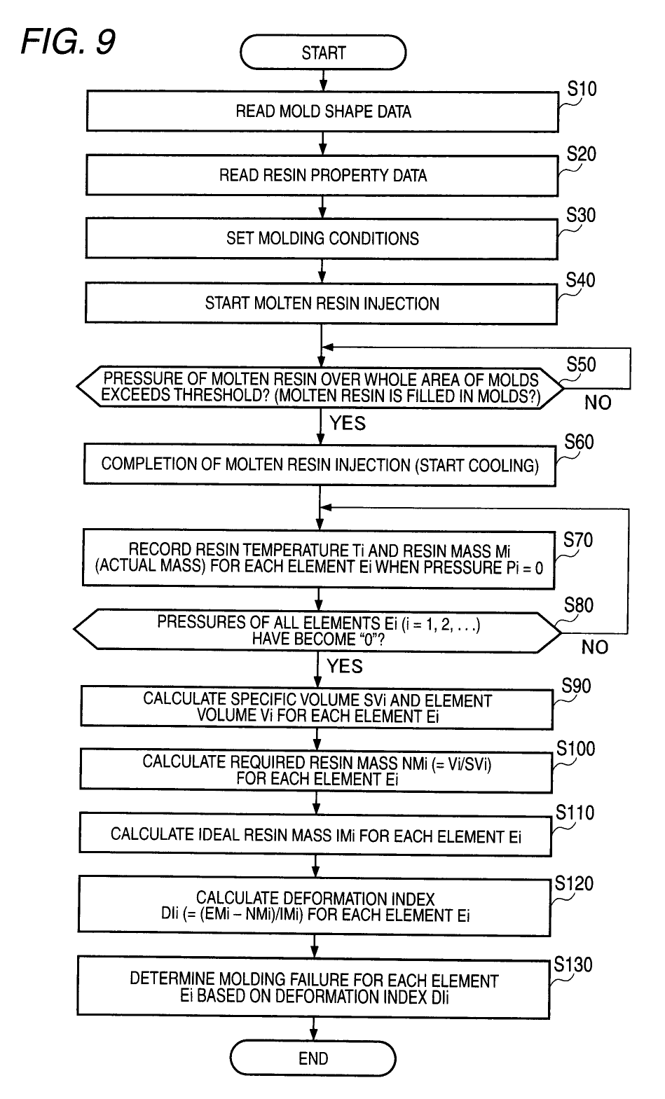

Hereinafter, the injection molding simulation system of this embodiment will be described in detail. FIG. 9 is a flowchart showing a procedure of determining a molding failure of a molded part using the injection molding simulation system.

In step S10, mold shape data are read in from the storage unit.

In step S20, resin propertied data are read in from the storage unit.

In step S30, molding conditions data are set. As molding conditions data, data stored in the storage unit or data inputted from the input unit is used. Specifically speaking, the molding conditions data include data required for a fluidity analysis, such as mold temperature, dwell pressure profile, in addition to injection temperature, injection flow rate and injection pressure of the molten resin in injecting it into the interior of the molds.

Next, in steps S40 to S80, a fluidity analysis of the molten resin which is injected into the interior of the molds which are set in an imaginary fashion is executed based on the mold shape data, resin properties data and molding conditions data. In the fluidity analysis, a time series analysis on changes in the behavior and state of the molten resin in the filling step and the dwell pressure application/cooling step is executed. An output from this fluidity analysis includes, for example, a mass distribution, pressure distribution and temperature distribution of the molten resin within the molds. Hereinafter, specific steps will be described.

In step S40, the injection of molten resin is started under the molding conditions which are set in the above-described step.

In step S50, it is determined whether or not the pressure of the molten resin over the whole area of the molds has exceeded a threshold. This threshold is set to determine whether or not the molten resin has been filled in the molds under a sufficient pressure. More specifically speaking, the threshold is set, for example, within a range of about 20 MPa to about 30 MPa, depending upon the thickness and shape of the molded part. If the determination is YES, it is understood that filling of the molten resin has been completed, and the procedure goes to step S60. On the contrary, if the determination is No, it is determined that the molten resin is flowing or moving within the molds, the injection of the molten resin is made to continue.

In step S60, the injection of the molten resin is ended in response to the determination in step S50 that the filling of the molten resin has been completed. Further, the cooling of the molten resin is started and the process in which the state of the molten resin changes is analyzed.

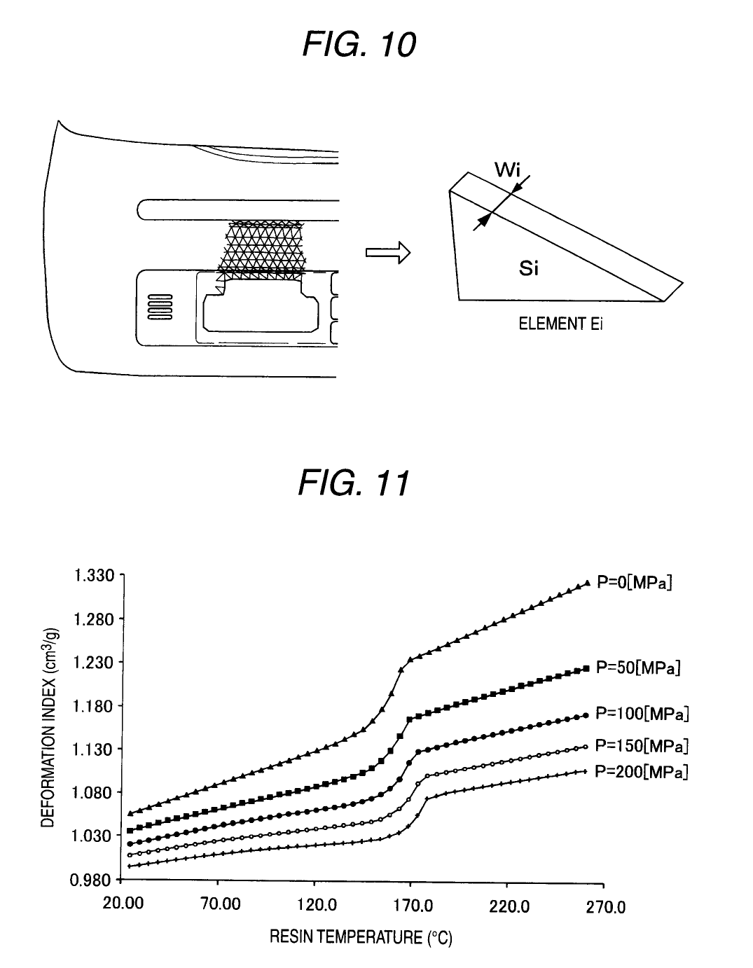

Specifically, the molten resin within the molds is divided into plural triangular elements Ei (i=1, 2, . . . ) as shown in FIG. 10, and a change over time in the state (resin temperature Ti, resin mass Mi, resin pressure Pi) of the molten resin is analyzed for each element Ei.

In step S70, a resin temperature Ti and a resin mass Mi at the time when the pressure Pi becomes “0” are recorded for each element Ei. In addition, the time when the pressure Pi becomes “0” is referred to as a set-up time ti. Additionally, hereinafter, the resin mass Mi at the set-up time ti is referred to as an actual mass Mi.

In step S80, it is determined whether or not the pressures Pi of all the elements Ei (i=1, 2, . . . ) have become “0”. That is, it determined whether or not the recording of resin temperature Ti, actual mass Mi and set-up time ti has been completed for all the elements Ei. If the determination is YES, the procedure goes to step S90, whereas if the determination is NO, the procedure goes to step S70.

In step S90, an element volume Vi of each element Ei, a specific volume SVi of each element Ei at temperature Ti and a specific volume SV0i at the room temperature (for example, 25° C.) or after setting up of the molten resin are calculated, respectively.

Specifically speaking, the element volume Vi of each element Ei is calculated by multiplying a surface area Si by a thickness Wi as shown in FIG. 10.

In addition, the specific volume SVi at temperature Ti and the specific volume SV0i after setting up of the molten resin are calculated based on a PVT curve which relates pressure, specific volume and temperature of the molten resin with each other as shown in FIG. 11.

In step S100, a required resin mass NMi of the molten resin for each element Ei is calculated. The required resin mass NMi is a physical quantity which indicates the mass of the element Ei when the molten resin at the time ti is filled in the element Ei. The required resin mass NMi is calculated by dividing the element volume Vi by the specific volume SVi as shown by the following expression (1).

Required Mass NMi=Element Volume Vi/Specific Volume SVi (1)

In step S110, an ideal rein mass IMi of each element Ei after setting up of the molten resin is calculated. This ideal resin mass IMi is a physical quantity which indicates the mass of the resin of the element Ei after setting up of the molten resin and is calculated by dividing the element volume Vi by the specific volume SV0i after setting up of the molten resin as is shown by the following expression (2).

Ideal Resin Mass IMi=Element Volume Vi/Specific Volume SV0i (2)

In step S120, a deformation index DIi which indicates the degree of deformation in each element Ei is calculated. The deformation index DIi is obtained by dividing the values obtained by subtracting the required resin mass NMi from the actual resin mass Mi by the ideal resin mass IMi, as shown in the following expression (3).

Deformation index DIi=(Actual Resin Mass Mi−Required Resin Mass NMi)/Ideal Resin Mass IMi (3)

In the above expression (3), the numerator of the deformation index DIi indicates the amount of excess or insufficient filled resin after injection molding. Consequently, when the actual resin mass Mi is less than the required resin mass NMi, the deformation index DIi takes a negative value. Because of this, the larger the degree of deformation becomes, the smaller the value of the deformation index DIi becomes. Further, by diving it by the ideal resin mass IMi which indicates a theoretical value of the amount of the resin after setting up of the molten resin, the deformation index DIi can be defined as an infinitely dimensional index which indicates whether the degree of each element Ei is excess or insufficient.

In step S130, a molding failure is determined based on the deformation index DIi for each element Ei. More specifically speaking, the deformation index DIi is compared with a determination threshold TH, and if the deformation index DIi is smaller than the determination threshold TH, it is determined that a deformation has taken place in the element Ei. That is, it is determined that a molding failure has taken place therein.

Here, if it is determined that a molding failure has taken place, in other words, if there exists an element in which the deformation index is smaller than the determination threshold TH, basically, the modification of the molding condition data and the mold shape data and the execution of the steps S10 to s130 are repeatedly performed until the deformation index exceeds the determination threshold TH in all the elements.

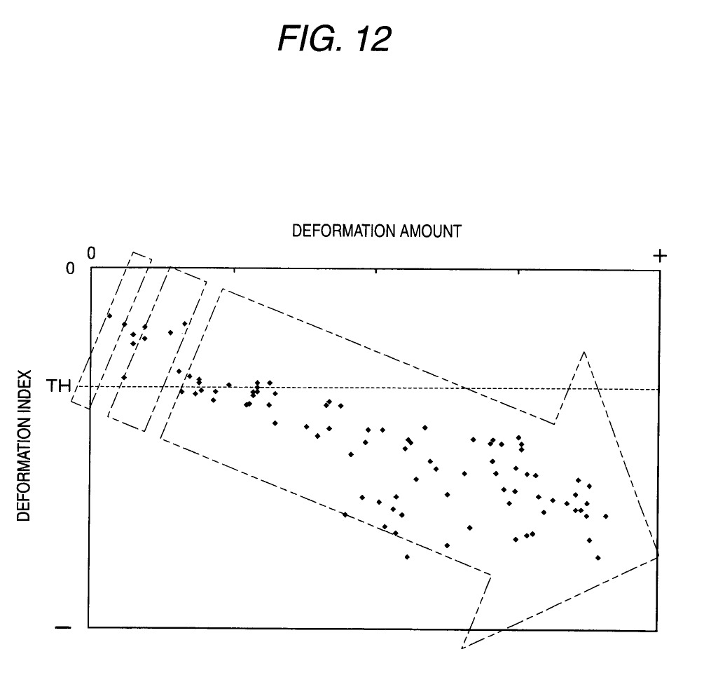

FIG. 12 is a diagram showing the result of the above-described injection molding simulation. The ordinate axis denotes a deformation index of each element which is calculated by the results of the simulation. The abscissa axis denotes an actual deformation amount of each element.

As shown in the diagram, it can be seen that there is a clear correlation between the deformation indexes and the actual deformation amounts. Namely, the smaller the deformation index becomes, the larger the deformation amount becomes. From the diagram, it is verified that the deformation index is useful for determination of the occurrence of deformation.

In addition, the determination threshold TH relative to the deformation index is set such that after a correlation between the deformation index and the actual deformation amount is induced, an actual deformation amount becomes smaller than a desired value.

According to the embodiment, the fluidity analysis is carried out on the molten resin which is injected under the predetermined molding conditions. Then, based on the results of the analysis, the actual resin mass Mi of the molten resin of each element Ei which is filled in the molds which are set in the imaginary fashion, and the required resin mass NMi of the molten resin of each element Ei are calculated. Further, the ideal resin mass IMi of the molten resin of each element Ei is calculated, and the deformation index DIi is calculated by dividing the deviation between the actual resin mass Mi and the required resin mass NMi by the ideal resin mass IMI, whereby the molding failure in each element Ei is determined based on the deformation index DIi. Thus, by determining the molding failure in each element Ei based on the deformation index DIi which is calculated by paying attention to the amount of molten resin of each element Ei, the occurrence of molding failure can be grasped with high accuracy. In addition, by carrying out the simulation to determine the mold shapes and molding conditions that can avoid molding failure, the time and cost which are required to prepare molds can be reduced while increasing the quality of molded products.

In the simulation system of the embodiment, by preparing the molding conditions data and the mold shape data which constitute the base of the simulation and repeatedly performing the injection molding simulation of steps S10 to S130 and the modification of the molding conditions data and the mold shape data, it is possible to determine the molding conditions and mold shapes which are free from molding failure. Namely, in the simulation system of the embodiment, it is possible to determine the molding conditions and molding shapes which are free from molding failure without making test sample molds and making test sample products manufactured by the test sample molds. However, the molding conditions and mold shapes which are free from molding failure may be determined more efficiently by using the simulation system of this embodiment in combination with actual preparation of test sample molds and test sample products.

In this case, the results of the test sample molds and produces are preferably reflected, when the injection molding simulation is carried out once and the molding conditions data and the mold shape data are then modified based on the results of the determinations made in the simulation. More specifically speaking, firstly, test sample molds are prepared based on the results of the determinations made in the injection molding simulation, and further, test sample products are prepared using the test sample molds. Then, the thicknesses of respective elements in the test sample products are measured, and the molding condition data and mold shape data are modified based on the measured values. By utilizing the information on the actual test sample products in performing the modification of the data, it becomes possible to determine the molding conditions and mold shapes which are free from molding failure more efficiently, that is, in a short period of time.

While the present invention has been shown and described with reference to certain exemplary embodiments thereof, it will be understood by those skilled in the art that various changes in form and details may be made therein without departing from the spirit and scope of the invention as defined by the appended claims. It is aimed, therefore, to cover in the appended claim all such changes and modifications as fall within the true spirit and scope of the present invention.

What is claimed is:

1. A method for preparing an analytical model for analyzing a shape of a molded part, the method comprising:
(a) measuring the shape of the molded part three-dimensionally to obtain shape data;
(b) dividing the shape data into two surfaces which define a thickness of the molded part;
(c) calculating a deviation between the divided two surfaces, as thickness data;
(d) relating the thickness data with the shape data;
(e) preparing a shape model of the molded part from CAD data related to the molded part;
(f) associating the shape model with the shape data; and
(g) imparting, to shape model, the thickness data related with the shape data in accordance with the association in step (f), thereby preparing the analytical model.

2. The method as set forth in claim 1,
wherein step (f) comprises: associating coordinate point groups of the shape model that are derived from the shape data with coordinate point groups of the shape data that are derived from the shape data, and
wherein step (g) comprises: imparting the thickness data related to the shape data, to a coordinate point of the shape model which is closest to a coordinate position of the shape data.

3. The method as set forth in claim 1,
wherein step (d) comprises: relating the thickness data with the shape data of one of the two surfaces, and
wherein step (f) comprises: associating the shape data of said one surface with a portion of the shape model which corresponds to said one surface.

4. The method as set forth in claim 2,
wherein step (d) comprises: relating the thickness data with the shape data of one of the two surfaces, and
wherein step (f) comprises: associating the shape data of said one surface with a portion of the shape model which corresponds to said one surface.

5. A simulation system for predicting a molding failure of a resin product through simulation of a process of manufacturing a resin product by injection molding, the system comprising:
a fluidity analysis executing section that executes a fluidity analysis of a molten resin which is injected into a product shape under certain molding conditions;
an actual mass calculating section that calculates an actual mass of the molten resin for each element, based on the result of the fluidity analysis;
a required mass calculating section that calculates a required mass of the molten resin for each element, based on the result of the fluidity analysis;
an ideal mass calculating section that calculates an ideal resin mass of the molten resin for each element; and
a molding failure determination section that determines a molding failure for each element, based on an index calculated by dividing a deviation between the actual mass and the required mass by the ideal mass.

6. A method of predicting a molding failure of a resin product through simulation of a process of manufacturing a resin product by injection molding, the method comprising:
(a) executing a fluidity analysis of a molten resin which is injected into a product shape under certain molding conditions;
(b) calculating an actual mass of the molten resin for each element, based on the result of the fluidity analysis;
(c) calculating a required mass of the molten resin for each element, based on the result of the fluidity analysis;
(d) calculating an ideal resin mass of the molten resin for each element; and
(f) determining a molding failure for each element, based on an index calculated by dividing a deviation between the actual mass and the required mass by the ideal mass.
